(19) United States
(12) Patent Application Publication
(10) Pub. No.: US 2004/0034686 A1
(43) Pub. Date: Feb. 19, 2004

(54) System and method for delivering targeted data to a subscriber base via a computer network

(76) Inventor: David Guthrie, Smyrna, GA (US)

Correspondence Address: PENNIE AND EDMONDS, 1155 AVENUE OF THE AMERICAS, NEW YORK, NY, 100362711

(21) Appl. No.: 10/643,840

(22) Filed: Aug. 19, 2003

Related U.S. Application Data
(63) Continuation of application No. 09/510,559, filed on Feb. 22, 2000.

(51) Int. Cl. G06F 15/16

(52) U.S. Cl. 709/203

(57) ABSTRACT

An information system includes a client component resident on a computer of the user, a server, and a database storage unit. The server is coupled to the computer and an internetwork such as the Internet. The server collects electronic information corresponding to a user's predetermined customized profile for delivery to the client component from the internet sites and the server. The database storage unit is coupled to the server. Electronic information collected by the server is used to populate at least one archive stored in the database storage unit. The archive is associated with the user's profile. The server sends checksums identifying the collected electronic information to the client component. The client component verifies that the electronic information has not previously been sent to the client component. The client component generates and transmits a message to the server indicating the electronic information that has been previously sent to the client component. The server deletes electronic information that has been previously sent to the client component from the archive. The server compresses electronic information remaining in the archive into a streaming format and sends the electronic information to the client component. The electronic information is decompressed by the client component and provided to the user via the computer. The invention also includes related methods.

### CROSS-REFERENCE TO RELATED APPLICATION

This application claims earlier filing benefits of provisional application No. 60/121,099 filed Feb. 22, 1999 naming David Guthrie as the sole inventor.

### FIELD OF THE INVENTION

This invention relates to the delivery of data over a computer network, and more particularly, to the delivery of data that conforms to information about subscribers within the subscriber base.

### BACKGROUND OF THE INVENTION

Computer networks are known and used to deliver files and other aggregate forms of data to users over the network. As usage of the internet has grown, so has the number of sites where files and other aggregate forms of data are stored. To facilitate users being able to review and retrieve information from the various sites on the internet, search engines have been developed. Some search engines are publicly available such as those implemented at www.yahoo.com, www.excite.com and www.altavista.com. Using the search engines at these sites, the user may type in terms related to topics of interest to a user. The search engine then identifies various sites where files or other data related to the topics of interest are stored. The user then uses information about the various sites displayed by the search engine to determine which ones the viewer wants to “visit” to evaluate the site.

While these publicly available search engines facilitate a user's identification of sites having information being sought by a user, they still require the user to conduct the search, review the results of the search and then conduct their own research on the various sites located by the search to locate information. In an effort to further facilitate a user's tasks to identify and retrieve data, agent programs have been developed that accept parameters identifying information of interest to a user. These agent programs then periodically conduct searches for data sites on the internet that have information related to the search parameters and collect relevant information from those identified sites. This information may then be downloaded to the user so the user may evaluate which information the user actually peruses.

These agent programs do alleviate some of the tasks associated with a user conducting their own research over the internet. However, the management of the agent program still must be performed by the user. In addition, agent programs do not parse the retrieved data files to eliminate redundant articles and images. Consequently, the user may have to sort through an unnecessary amount of data. Also, if any of the files downloaded included data objects that require interaction with a user, the user must go to the site on the internet and interact with that file and data object as the agent program is usually unable to do so.

What is needed is a system that does not need to be managed by a user but which provides information relevant to a user's needs on a periodic basis.

What is needed is a system that eliminates redundant files and images corresponding to identified parameters for data of interest to a user before delivering the data to the user for review.

What is needed is a system that permits a user to interact with data objects even though the data object is not being communicated during a session with a site from which the data object was retrieved.

### SUMMARY OF THE INVENTION

These and other limitations of previously known systems for retrieving data for users are overcome by a system and method of the present invention. The informational system of the present invention is comprised of a client component resident on a computer system at a user's computer and a server that collects electronic information corresponding to each user's customized profile for delivery to the client component. The information collected includes documents and images received from internet sites or it may include content from servers located at the server site facility. In one application of the present invention, the users are doctors and the content may include articles from medical publications addressing a doctor's practice specialty, information provided by sponsors for the informational system, and miscellaneous information of personal interest to a doctor. Documents and images from these various sources are retrieved and used to populate archives defined by a profile associated with an identified user for each client component in the system. Prior to delivering the contents collected for the archive, checksums identifying the articles and images within an archive are sent to the corresponding client component which verifies that an article or image has not been previously sent to the client. If the client sends a message to the server indicating that one or more articles or images have been previously transmitted to the client, those redundant elements are deleted from the archive. The remaining elements of the archive are then compressed in a streaming format and delivered to the client component. The downloaded archive is decompressed by the client component and provided to the user.

### BRIEF DESCRIPTION OF THE DRAWINGS

The accompanying drawings, which are incorporated and constitute a part of the specification, illustrate preferred and alternative embodiments of the present invention and, together with the general description given above and the detailed description of the embodiments given below, serve to explain the principle of the present invention.

FIG. 1 is a block diagram of a system architecture incorporating the inventive system and method of the present invention; and

FIG. 2 is a depiction of communications between a client and server implementing the system of the present invention.

### DETAILED DESCRIPTION OF THE INVENTION

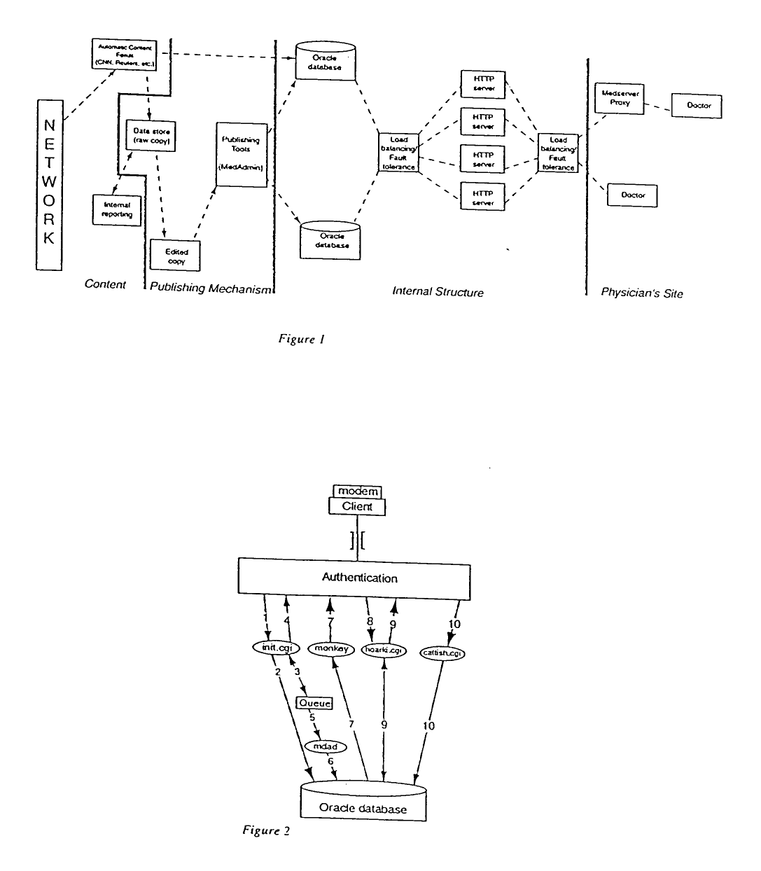

The informational system of the present invention utilizes the Internet pipeline to deliver news and information to a user's desktops. Start to finish, the informational publishing system can be briefly summed up in the four-part diagram shown in FIG. 1.

Content (Network—Automatic Content Feeds—Data Store—Internal Reporting)

Content consists of everything the physician receives from the system, including specialty specific medical news, policy news, continuing medical education (CME), reference resources, financial, travel and lifestyle information.

The Publishing Mechanism (Data Store—Edited Copy—Publishing Tools)

The tools used to create, edit and ‘publish’ the content for a user. These include third-party applications for content creation, the Greenburg News Network (GNN) publishing tool Medcast Administrator, Continuing Medical Education test creation, and server side publishing.

Internal Network Architecture (Oracle database—Load balancing/fault tolerance—HTTP server)

This includes the hardware and software GNN uses to process, store, and deliver content to the end users.

Physician'Site (Medserver Proxy—Server)

In a preferred embodiment, the users are physicians and the data content is targeted for physicians and their medical practices. The system discussed below is made with reference to this preferred embodiment. The terms ‘Medcast server’ and ‘Medcast client’ refer to the server and client components in this preferred embodiment. Details of the hardware and software used by the physicians and the manner in which they access Medcast content include a single-user set up with a modem; single user on a LAN with a wide area network; or multi-users on a Local Area Network (LAN) with a Medcast site server.

All Medcast client software is developed using Microsoft's visual C++, due to its wide acceptance, speed, and array of Software Development Kits (SDKs). Additionally, the ability to cross compile this software is important for compatibility with future upgrades and products.

All client software is 32-bit. This provides users of the inventive system with fast, flexible applications suitable for multi-tasking and multi-processing operating systems. The informational system of the present invention operates under Windows 95/98 and Windows NT operating systems, with twenty-four megabytes of RAM, though thirty-two is preferable.

Site Configurations

Single-user Set up with Modem

A simple installation requiring software, hardware and configuration of an Internet Service Provider (ISP).

Single-user on a Local Area Network with a WAN

An installation of the software, configuration of ISP, and installation of hardware and Ethernet card for the LAN.

Large multi-User installations on a LAN with a Medcast site server

The proxy server of the present invention is Windows NT-based, which is designed to serve all Medcast subscribers on the LAN. Hardware for the proxy server consists of a 400 MHz Pentium with Ethernet, 64 Mb of RAM, tape backup, 4 Gb hard drive, 32x CD-ROM, 10/100 Ethernet Card, monitor, mouse and keyboard.

The proxy software server system acts as a proxy to the Medcast Broadcast Center. It enables each local user to receive updates from the local proxy server instead of the Medcast Broadcast server. This reduces the overall bandwidth requirements on the local LAN's internet Connection and enables the local administrator to control the time of delivery and updates. It also provides the administrator controls for handling access to the proxy server.

CLIENT SERVER COMMUNICATIONS

To deliver updates to a physician's site, the system of the present invention uses the TCP/IP standard protocol with a standard Internet connection. Configurable updating routines are available, allowing physicians to update their systems in the middle of the night if they use Microsoft's PPP dialer with Windows 95/98 or NT. If a physician is on a direct connection she or he can receive numerous updates throughout the day. The basic update process is described with reference to FIG. 2:

Authenticate

Authentication happens before every action. User name and password given. Init.cgi sends information to the database and learns whether it's correct or not. (Or, to use an analogy, you've just walked in the door of a restaurant.)

1. Transmit log riles and content information (Analogy: you tell folks in the restaurant what you've been doing since last you saw them.)

2. Store log files and content information into the database (Analogy: your order number is generated.) Record session in queue (Analogy: your order number is given to you.)

4. Return session ID and server time (Analogy: You order “A number five, please.”) Get queue information and content list (Analogy: the chef receives your order.)

5. Get queue information and content list (Analogy: The chef receives your order.)

6. Generate file list and custom files (Analogy: Gathering the ingredients for what you ordered.)

7. Download list of files. This is a list of content identifiers the server thinks the client should have. (Analogy: on the server side this would consist of the entire recipe of what you just ordered. But what's sent to you, the client, is a stripped down version: instead of the ingredients of your order, you just see “A number five consists of: cheese burger, rhubarb pie, milk”

8. Return optimized list. The client sends Hoark a list of files that the client doesn't require. (Analogy: You've learned exactly what a number five is and decide you don't want the milk because you brought one with you, so you return a list of what you don't want.)

9. Read files. Hoark reconstitutes what you've sent back, being sure you didn't reject something that wasn't on the list of offerings. (Analogy: the chef makes sure you didn't reject something that didn't come with your order.)

10. Download files. The files are downloaded. (Analogy: the dish is served.)

11. Acknowledgment. The client indicates all the files were received and whether or not there was a problem, this session is done. (Analogy: Bye, great pie, I'll be back!)

A more detailed breakdown of the client server communications follows:

Authenticate

Summary

Every interaction between the client and the services available at the server is mediated by a web server. This mechanism provides authentication, logging, and (potentially) load balancing using a single, popular, off the shelf tool. It also obviates any network code in the server side elements (the CGIs).

Every connection instance is authenticated using the standard “Basic Authentication” provided by the web server. Preferably, the authentication module which is integrated with an Apache web server and the module queries an Oracle database for authentication data. No data is transferred until authentication is successful.

Once past this initial step the client and the server side (CGI) process are connected. The CGI process has access to the client user name (via the remote_user environment variable) and a communications stream via Standard 10.

Details

The preferred authentication module used under Apache consults an Oracle database. It uses the popular “External Auth” module for Apache.

Configuring the web server to use this authentication method is done using SetExtemalAuthMethod as:

SetExternalAuthMethod GNNAUTH function

Then for each table/column combination, an AddExternalAuth directive is added. The form of the directive is:

AddExternalAuth GNNAUTH GNNAUTH:table,user_col,passwd_col,style where table is the Oracle table name, user_col is the column name of the username, and passwd_col is the column name of the password.

Style should be one of “clear” for plaintext passwords or “des” for unix style 13 character passwords.

If you use the special table name “oracle” then instead of checking an Oracle table, the given username and password is used to attempt to log into the Oracle database. If that works a “pass” is reported. (The other 3 arguments are ignored.) Transmit Log Files And Content Information

Summary

This is the first step performed by init.cgi. The article request data is sent to the cgi by the client, the size of which is determined by an HTTP header. This data is put into the database LOB store. Next, the client activity log is sent to the server, the size of which is also in an HTTP header, and saved to a file on the server's file system. These log files are to be gathered and parsed by a separate process.

Details

User Activity Log

The Medcast client applications track the user's activity in a log file and transmit that log file to the Medcast server during each update. Once a log file has been transmitted, it is deleted from the client machine and a new log file is begun. The log file format is:

USERNAME\tUID\tMACHINEID\n
ACTION CATEGORY\tACTION\n
ACTION CATEGORY\ACTION_ID\n

The file consists of an initial line identifying the user and the machine being used. The following lines identify the sequence of actions the user performed since the previous update.

Action Categories

Action categories describe the general action that was performed. The categories consist of:

AD an ad played

ARC saved an article to the archive

ART an article was viewed

BTN a button was pressed

CHN the table of contents page for a channel was viewed via the channel selector or a channel://command

ERR an error occurred

Action Identifiers

Action identifiers can have different meaning depending upon their associated action category.

| | |
|---|---|
| AD | the ID of the ad that was played; it is represented as <AID>.<GID> |
| ARC | the ID of the article that was archived; |
| | it is represented as <AID>.<GID> |
| ART | the ID of the article that was viewed; |
| | it is represented as <AID>.<GID> |
| BTN | the name of the button pressed; |
| | (if the button simply pulls up a TOC page, |
| | then the CHIN action is fired instead) |

EMAIL
INTERNET
OPEN
FIND
CUSTOMIZE
DAILY (Daily Broadcast)
EVENT (Live Events)
SPONSOR (Sponsor Channels)

| | |
|---|---|
| CHN | the ID of the channel whose TOC page was viewed; |
| | It is represented as <GID> |
| ERR | an error type identifier followed by an |
| | error message; valid error types are: |
| | data an error in the databases; the accompanying error message will |
| | contain a number identifying the specific error |
| otbx | an error with the outbox; the accompanying error message contains |
| | some information about the offline form which failed to submit |

Init.cgi returns a status 500 if it has an internal failure. All server errors are logged.

Store Log Files And Content Information

Summary

This step happens pseudo-inline within init.cgi. The activity log data is streamed directly to a file as it is received. The article request information is stored in an intermediate buffer to be spooled to the server database. The LOB containing the article request contains ASCII data, as described above. This data is later interpreted by the MDAD process.

Details

See Appendix B, Step 4+for examples of input, output and init's code.

Record Session In Queue

Summary

A new record is created in the download_queue table, populating the appropriate fields.

Details

The medcast_user_id, status, source_ip, queue_type fields are populated. The medcast_user_id is the user identification that the client uses to connect to the server, the status is set to the state of QUEUED as defined in download_queue states.h, the source_ip is passed from HTTP header information, and queue_type is set to ‘A’ or ‘M’ as gathered. from the HTTP_UPDATE_TYPE environment variable. See Appendix B for examples of input, output and init's code.

Return Session ID and Server Time

Summary

The session_id assigned by the database to the newly inserted record in the download_queue table, is sent to the client along with the number of seconds elapsed on the server's clock since Jan. 1, 1970.

Details

These values are returned to the client as name=value pairs in the form of:

session_id=10859

time_t=902361932

See Appendix B for examples of input, output and init's code.

Get Queue Information and Content List

This is a process request list which generates a list of articles and other lobs, plus a custom archives For more details, see “Tradecast client to server request” in Appendix B-2 and all of Appendix D.

Generate File List and Custom Files See Appendix D for mdad information.

Download List of Files

Summary

This step is performed by monkey.cgi. This list of files consists of a datum pair for each file, the pairs being an MDS checksum of the file as stored in the server database, and the length of the file. This list of datum pairs is compared against files stored in the client database and duplicates are removed. (See Appendix A for examples of input, output and monkey's code.)

Details

The monkey CGI return data is composed of:

Header: any lines beginning with # are part of the header and treated as comments. The header may or may not contain useful information but at the least it contains the version of the data format, and a current Unix-style date (3) string.

Data: provides a unique fingerprint for each file the server believes the client needs (the fingerprint consists of an MD5 checksum and a data length). The MD5 appears as a hexadecimal string 128 bits long, followed by a space, and then the long integral representation of the file's length as stored in the server database. The line is ended with the new line character ‘\n’.

#Version: 1.0

# Date: Jun. 22, 2001

$$\begin{matrix}\begin{matrix}\begin{matrix}A fingerprint for every file that follows comes after the monkey - p header . \\ The fingerprint is the ASDII representation of a 3 \; 2 bit hex number representing\end{matrix} \\ the MD 5 checksum , a space , then the size of the file is represented in bytes in\end{matrix} \\ ASDII digits .\end{matrix} \} monkey data$$

Monkey.cgi returns an HTTP status of 509 if the server isn't ready for the client, and a status 510 if the client requests bogus article information, or MDAD is unable to process the request data.

Monkey.cgi returns a status 500 if it has an internal failure. All server errors are logged.

Return Optimized List, Read Files, and Download Files are Combined and Explained in the Following

Summary

Hoark is the service which sends content to the client system. In a previous step, the system has generated a download offerings list based on client input. This information (or a derivative) is available both to the client and the server.

Upon connection, the client transmits a selection of that list consisting of items which the client does not want downloaded (because it already has them locally). The server then transmits the remaining items from the original download offerings list.

Details

request phase: Client connects and sends a newline separated list of pointers into the offerings list (ASCII representation), followed by a blank line:

3\n

23\n

9\n

\n

response phase: Server sends a stream of commands to a virtual machine within the client. The generic command format is:

| | | |
|---|---|---|
| tag (1 byte) | length of data in bytes | data (if any) |
| | (32 bit unsigned integer) | |

All numeric data is transmitted in network byte order.

Tag definitions:

| Tag Symbol and transmitted | Data | |
|---|---|---|
| value | Length | Dates and Notes |
| END_CHANNEL(1) | 4 | single channel ID (32 bit unsigned integer) All |
| | | content associated with this channel has now |
| | | been transmitted. |
| ENCODING(2) | 5 | encoding_type (1 byte) |
| | | how_many (32 bit unsigned integer) |
| | | The next how_many bytes of the command |
| | | stream will be encoded according to |
| | | encoding_type. It is expected that zlib style |
| | | compression will be the most popular option. |
| | | Only one ENCODING is allowed at a time. |
| CONTENT(3) | ? | Data overwrites virtual machine content buffer |
| NO_CONTENT(4) | 0 | Effectively requests the client to load the virtual |
| | | machine content buffer using the content |
| | | associated with content_ID command. The |
| | | client should be able to do this because it was |
| | | listed as an item the client already has. |
| ARTICLE_INFO(5) | ? | Opaque article info, at least contains article and |
| | | channel id Write the content buffer as this article. |
| CONTENT_ID(6) | ? | MD5 sig and content length (ASCII |
| | | representation), separated by one space. |
| | | This command always immediately precedes the |
| | | content or no_content command which it's |
| | | associated with. |
| COMMENT(7) | ? | Comment text which may be logged by the |
| | | client. |
| END_OF_TRANSMISSION(9) | 1 | status (1 byte) |
| | | All done, server drops the connection |
| | | Nonzero status indicates error condition. |
| START_OF_TRANMISSION(9) | 4 | server_version (32 bit unsigned integer) |
| | | Must be first command sent to client. |
| SESSION_ITEMS(10) | 4 | The number of content and no-content tags to be |
| | | transmitted this session (a 32 bit unsigned |
| | | integer). |
| | | This command is optional and may appear |
| | | anywhere in the session stream. |

Encoding and Compression:

The idea with the table above is that after an ENCODING command, the next n bytes of the data stream are decoded.

The client implementor writes a decoder atop whatever is reading the socket. This keeps track of the present encoding (if any) and returns uncompressed data to the client application.

Acknowledgment

See Appendix C for acknowledgment information.

### APPENDIX A

Appendix A: Monkey CGI

The Monkey CGI is the second step in the download process. It performs several actions both in the database, with input data, and returning data.

Monkey Process:

1. Retrieve HTTP_SESSION_ID from the environment.

2. Check to see if the user is active; disconnect if not.

3. SELECT the status field FROM download_queue WHERE session_id matches HTTP_SESSION_ID

4. If status ( as defined in download_queue_states.h ) is less than PROCESSED return: “Status: 509 Service not ready, try back later” “Retry-after: 30”and disconnect.

5. Else if status=BOGUS return: “Status: 510 Invalid article request data” and disconnect.

6. Else set status=MONKEYING and COMMIT database.

7. Search mdad_article_listing for all records whose session_id field matches HTTP_SESSION_ID.

8 Set crit field of each found record to the value of a sequentially updating counter, starting at 1.

9. Using the gnnlob_id field value in the found record, find the matching record in the gnnlob table, and save the length and md5 checksum fields.

10. Set status =MONKEYED in the download_queue record and COMMIT the database.

11. Return header and list of md5/lengths (a newline separates these blocks)

Monkey's Data:

monkey.cgi uses two database tables, download_queue and mdad_article_listing. See comment in the CME section regarding these.

The Input:

HTTP Headers:

HTTP_SESSION_ID—The session_id that the client was given by init.cgi.

The Output:

The Header:

#Version: 1.0

#Date: Wed Aug 5 16:33:29 EDT 1998

The List:

54c3057549c969358fe33e41d8a2a7fb 1056

b43ca51181 a2a97615a06a42a7c1170 3545

d382eca33fedba00cd24ff94f45bfa7a 1376

b4e23ef9158f56b410417c29a08d0c11 29172

77bb4d1578f8c64bla6ab8c4678b8409 4376

The Code:

This CGI is composed of the following files:

monkey-cgi.cpp - Source file for CGI functions
monkey-db-funcs.pc - Source file for Oracle functions

monkey-cgi.cpp
This file contains the following functions:
take_a_pee - list the results for a user or all users
status_not_ready - return as status
indicating that the client's download_queue record isn't ready.
status_queue_failure -
return as status indicating that the client has requested bogus articles

take_a_pee

Declaration:

short take_a_pee(const list<droplet>& droplets);

Arguments:

droplets - a linked-list of droplet structs.

Returns:

0 on success.
−1 on failure.
This function is very simple. It outputs a success
status, a header, and then
iterates over all items in droplets
outputting each item's md5 checksum
and length.

status_not_ready

Declaration:

void status_not_ready( );

Arguments:
Returns:

This function is called when it is determined
that the server is not ready
for the client to connect. It outputs an HTTP
status 509 and disconnects.

status_queue_failure

Declaration:

void status_queue_failure( )

Arguments:
Returns:

This function is called when it is determined that the client has requested bogus article. It outputs an HTTP status 510 and disconnects.

monkey-db-funcs.pc

This file contains the following functions:

gather_droppings -
retrieve article information from the database for the client
gather_droppings

Declaration:

short gather_droppings(long session_id, list<droplet>&droplets)

Arguments:

session_id - session_id given by the client.
droplets - empty list of droplet structs.

Returns:

0 on success.
−1 on failure.

This function is the checksum of the CGI. It performs all the checks described above, then queries the database for the md5 and length information that the client needs, and places them in a droplet struct, which is added to the droplets list.

### APPENDIX B

Appendix B: INIT CGI

The Init CGI is the first step in the download process. It performs several actions both in the database, with input data, and returning data.

1. Read REMOTE_USER, HTTP_COMPRESSED, HTTP_LOG_LENGTH, HTTP_ARTICLE_LENGTH, and LOG _PATH from the environment.

2. Check the database for the state of the user. If they're inactive, drop the connection.

3. Construct path to file to contain activity log data. This is in the form of:

LOG_PATH[/]REMOTE_USER-<time>.log [.gz] where<time>is in the form of 21:34:28, and .gz is appended if HTTP_COMPRESSED is set to ‘Y’.

4. Open the log output file.

5. Read in HTTP_ARTICLE_LENGTH bytes of data to a buffer, to be stored in the database.

6. Read in HTTP_LOG_LENGTH bytes of data to the log file opened above.

7. Close the log file

8. Read REMOTE_ADDR, REMOTE_USER, and HTTP_UPDATE_TYPE from the environment.

9. INSERT INTO download_queue user_id, source ip, update type as REMOTE_USER, REMOTE_ADDR, HTTP_UPDATE_TYPE, retrieving the session_id of the new record, which is inserted automatically by a database trigger.

10. INSERT the article request data buffer into the LOB store using the request_data column to save the gnnlob_id of the stored data.

11. COMMIT the database.

12. If successful, return the session_id and the value of time( NULL) to the client.

The Input:

HTTP Headers:

Set by the HTTP server for all cgi's:

remote_user—The id of the authenticated client user.

remote_addr—The IP address of the client machine.

Set by the HTTP server especially for init.cgi:

LOG_PATH—Path to use for the saved activity log file.

Set by the client when connecting:

HTTP_COMPRESSED—Indicates if the activity log data is zlib compressed.

HTTP_LOG_LENGTH—Length in bytes of the activity logo data.

HTTP_ARTICLE_LENGTH—Length in bytes of the article request data.

HTTP_UPDATE_TYPE—Values of ‘A’ or ‘M’ indicate automatic or manual download, respectively.

1=inhouse; to staged content is downloaded. T=testing; mdad is being tested.

Tradecast Client to Server Regitest/Article Request Data:

Summary

ARTICLES:71; 1+

ARTICLES:69; 1+

ADS_IN:75;

ADS_IN:51

ARTICLES:81; 1+

Details

ARTICLE GROUP DOWNLOAD REQUEST

ARTICLELIST_STR “:”<gid>“;”<article limit><article group list>NL

| | |
|---|---|
| <gid> | = group id |
| <article limit> | = “ ” \| “<”<number>“,” |

(signifies that no more than ‘number’ articles should be downloaded)

| | |
|---|---|
| <article group list> | = <article> “—” <article> |
| <article group list> | = <article> |
| <article group list> | = <article group list> “,” <article> |
| <article group list> | <article> “+” |

where the plus ‘+’ signifies all articles <= listed article
<article group list> = <article group list> “,” <article<“-”<article>
where the dash ‘-’ signifies a range of articles

| | |
|---|---|
| N L | = “\n” |

ARTICLELIST_STR = “ARTICLES”

(if no articles exist, request should be 1+)

- - - “article limit” is being disabled as a feature

ADS DOWNLOAD REQUEST

ADSLIST_STR “:”<gid>“;”<ad-list<
<ad> = download id of ad
<ad_list> = “ ”
<ad_fist> = <ad>
<ad_list> = <ad>, <ad-list>
ADSLIST_STR = “ADS_IN”

where ad_list is all the ads for the given group.

STOCKS DOWNLOAD REQUEST

STOCK_LIST_STR “:”<5-letter-code-list>NL
<5-letter-code-list> = 5-letter-code-list>“,”<5-letter-code<
<5-letter-code> = code assigned by stock exchange (nyse, nysdex, etc)
----‘JANSX’, etc (at most MAX_STOCKS per line)
STOCK_LIST_STR “STOCK”
NL = “\n”
MAX_STOCK = 25

Activity Log Data:

| BTN | CUSTOMIZE |
|---|---|
| BTN | FIND |
| BTN | CUSTOMIZE |
| BTN | CUSTOMIZE |
| BTN | FIND |
| BTN | CUSTOMIZE - Kevin |
| CHN | 56 |
| CHN | 0 |
| ART | 1.1 |
| CHN | 7-09520 |
| ART | 1.1 |
| CHN | 0 |
| ART | 1.1 |
| CHN | 5118196 |
| ART | 1.1 |

The Output:

The output consists of very simple name/value pairs.

session_id=1034587

time_t=902361932

session_id is the value that the client should return when connecting to monkey.cgi, hoark.cgi, et. al. time_t is the value returned by calling time(NULL). It is used to determine what time the server thinks it is, so that the client and the server can be in sync.

The Code:

This CGI is composed of the following files:

init_cgi.cpp—Source file for CGI functions init_db_funcs.pc—Source file for Oracle functions

init-cgi.cpp

This file contains the following functions:

read_log_file - read the log file and request data in from the stream
print_output - return data to the client

read_log_file

Declaration:

short read_log_file(string &request_data)

Arguments:

request_data -
string to be populated with the article request data from the
client.

Returns:

0 on success
−1 on failure
This function is designed to read in a specific
number of bytes of article
request data and a specific number of bytes of activity log data as
described above.

print_output

Declaration:

short print_output(long session_id)

Arguments:

session_id - session_id given by the client.

Returns:

0 on success.
−1 on failure.

This function returns to the client the session_id and time_t identifiers as described above.

init-db-funcs.pc

This file contains the following functions:

add_dlq_record - insert a new record into the download_queue table

display_options

Declaration:

short add_dlq_record (long &session_id,
const string & request_data);

Arguments:

session_id - session_id given by the client.
request_data - contains the request date from the client.

Returns:

0 on success.
−1 on failure.

This function inserts a new record in to the download_queue table and adds the article request data from the client to the LOB store as described above.

### APPENDIX C

Appendix C: Catfish CGI

Catfish is the last cgi called by the client and its purpose is to clean up download_queue and mdad_article_listing, custom info and request data.

When:

Download-queue status is:

HOARKED or

DELETING or

BOGUS

session_id exist in download_queue user_id is user_id for given session

Protocol:

client sends session_id as an HTTP header (SESSION_ID: session_id) such that Apache sets the environment variable

HTTP_SESSION_ID. gets the user_id from the appache auth.

Success:

200 status

LAST_UPDATE: TIME TO BE RETURNED TO INIT ON NEXT UPDATE

DAILY_UPDATES: list of times for client to do its next updates

Errors:

503 unable to connect to database

507 unable to cleanup download queue

400 improper input

/opt/gnn/bin/catfish.cgi.cron_cleanup calls

opt/gnrn/download_htdocs/catfish/catfish.cgi.cron_cleanup

/opt/gnn/download_htdocs/catfish/catfish.cgi.cron_cleanup

sets env

Cron cleanup:

CATFISH_CLEANUP_TIMEOUT number of seconds since last mod to denote expired download queue item

CATFISH_EXTRA_WHERE extra where clause for cleanup

CATFISH_ALL just needs to be set

HTTP_SESSION_ID CLEANUP_ALL

GNN_DBUSER oracle user

GNN_DBPASSWD password for the oracle user

Basically calls catfish.cgi with CATFISH_ALL set and HTTP_SESSION_ID set to “CLEANUP ALL” and catfish will go through the download queue and get any items that have not been modified in the last X seconds where X is CATFISH_CLEANUP_TIMEOUT if set to the default (currently 1 day). Overrides catfish constraint that the queue time have one of the approved statuses.

### APPENDIX D

Appendix D: Catfish CGI

Source files uniquely for mdad

make_download_archive.c

mdad_tmp_table.pc

make_archives.c

source files uniquely for mdad.runnerd

mdad.runner.c

Environment variables used by mdad and mdad.runnerd

mdad path

path to mdad for mdad.runnerd to run may be full or relative mdad.runnerd does not chdir.

email_error_to

address to send email errors to default “<tradecast.server.error@GNNcast.net>”

gnn_dbname

oracle sid

medcast_download_spool

spool directory for custom data

debug_tmp_dir

where to put tmp files

Log Files

mdad.runnerd

$TC_LOG_DIR/make_archive. log—runtime log

debug logs—latest.log is the latest log

$ DEBUG_TMP_DIR/debug/download/mdad.runnerd.dir/*

mdad

$TC_LOG_DIR/mdad.log—runtime log

debug logs—latest.log is the latest log

$ DEBUG_TMP_DIR/debug/download/INSTANCE/mdad.dir/*

$ DEBUG_TMP_DIR/debug/download/mdad.dir/*

debugging log files may be eliminated by not compiling with HDEBUG defined

USAGE: mdad.runnerd.csh [NUMBER]

USAGE: mdad.runnnerd [NUMBER]

NUMBER is the number of mdads to keep going. Default is one max, and is currently 64. It is set by the number of members of the array mdad_kids in mdad.runner.c

mdad.runnerd.csh

is a shell script which sets some env variables and runs itself in the backgroup and keeps mdad.runnerd going. If mdad runnerd exits with an exit status of 0, mdad.runnerd.csh also exits with an error status of 0.

mdad.runnerd

is a compiled executable which keeps X mdads running where X is the first arg on the command line.

1<=X<=max mdad kids (currently 64)

Email of Errors

Every time a kid stops (dies/quits) mdad.runnerd restarts the kid, logs it, and sends email to mdad@gnncast.net if it has not sent email within the last X seconds (currently 300).

If mdad.runnerd restarts X kids within Y seconds, and it's been more than Z seconds since it last sent email to alert. mdad. has problems @ GNNcast.net, it does so.

Y is currently 15 minutes (15 * 60)

Z is currently 20 minutes (20 * 60)

X is currently 128 defined by the number of members of kwpq

Signals

hup—kills off all kids and executes itself

term—kills off all kids and quits

int—ditto

quit—ignored

Note

opens the runtime logfile with an exclusive to write so only one mdad.runnerd may run at a time.

Bugs

does not kill off mdads still running when it starts

USAGE: mdad [LOGFILE ID] [SLEEP SECONDS]

logfile

negative pid of parent do not try to open

1 attempt to open runtime log file of mdad.runnerd exclusively for writing.

sleep seconds

number of seconds to do nothing between no items found in the queue.

Plan of attack

startup cleanup

Looks for mdad_tmp_tables for the current host (application server) which needs to be cleaned up (dropped). Resets any download_queue time back to QUEUED (20) that are at PROCESSING (30) if the mdad_tmp_table which created them does not exist.

Main Processing Loop Steps

1. Finds first queue request in download queue, first request is first one by queue_type then by create time where queue type is sorted by:

a. tc_dlqt_manual (‘M’)

b. tc_dlqt_in_house (‘H’)

c. tc_dlqt_automatic (‘A’)

d. tc_dlqt_testing (T)

2. Sets that status to PROCESSING (30) and fills in the mdad_tmp_table in the download_queue

3. Calls process_article_requests to obtain the request data in a parsed format file. Currently this functionality is in imglue.so

4. Sets up temp param files. This is some of the custom info, mostly about the articles/channels of which the client needs to know. See OW mdad processes request data for more info

5. Processes request filling up mdad_article_listing and adding to param files and inserting custom info into the tcar archive (custom archive).

6. Put the param files as the last items in the tcar archive.

7. Set the status of the download_queue item to be processed.

8. 7 goto 1.

How mdad Processes Request Data

1. Creates one or more SQL queries from the request list which adds the article global ids to the tmp table, and executes them. After the initial insertion of articles into the tmp table, a query is performed to add all the offspring (children, grandchildren, etc ) of all articles which are in the tmp table. Currently this is done in such a way that the article is only in the tmp table once. It may be more efficient to have this uniqueness performed in step 2.

2. Takes all the lists of article global ids in the tmp table and adds them to the mdad_article_listing table, leaving only tcar_name and cnt+++to be filled in later. +++the cnt column is filled in by monkey after determining what order to send down the fingerprints (md5 cksum and len).

3. Runs through the mdad_article_listing table for this session, adding appropriate info to the param files for each article, and filling in the tcar_name column of the table.

4. By looking at the last_update time, and decrementing it by a fixed amount, adds state info to the param files about deleted articles, channel mods.

5. Examines the clients overall version and adds the appropriate items to the download list along with a script to tell the client what to do with the new version update files.

1. An information system coupled to an internetwork for use by at least one user, the information system comprising:
a client component resident on a computer of the user;
a server coupled to the computer and the internetwork, the server collecting electronic information corresponding to a user's predetermined customized profile for delivery to the client component from the internet sites and the server; and
a database storage unit coupled to the server, the electronic information collected by the server used to populate at least one archive stored in the database storage unit, the archive associated with the user's profile.

2. An information system as claimed in claim 1 wherein the server sends checksums identifying the collected electronic information to the client component, the client component verifies that the electronic information has not previously been sent to the client component, the client component generates and transmits a message to the server indicating the electronic information that has been previously sent to the client component, the server deleting electronic information that has been previously sent to the client component from the archive, the server compressing electronic information remaining in the archive into a streaming format and sending the electronic information to the client component, the electronic information decompressed by the client component and provided to the user via the computer.

3. An information system as claimed in claim 1 wherein the electronic information includes text articles and images.

4. An information system as claimed in claim 3 wherein the text articles and images contain medical information.

5. A method comprising the steps of:
a) collecting electronic information with a server, the electronic information corresponding to a user's predetermined customized profile for delivery to the client component from the internet sites and the server;
b) populating an archive in a database with the collected electronic information, the archive associated with the user's predetermined customized profile;
c) sending checksums identifying the electronic information from the server to the client component;
d) receiving the checksums at the client program;
e) verifying at the client component that the electronic information has not previously been sent to the client component, based on the checksums;
e) generating and transmitting a message from the client component to the server indicating the electronic information previously sent to the client component;
f) receiving the message from the client component at the server;
g) deleting electronic information that has been previously sent to the client component from the archive, based on the received message;
h) compressing the electronic information remaining in the archive into a streaming format;
i) sending the electronic information to the client component;
j) decompressing the electronic information at the client component; and
k) providing the electronic information to the user via the computer.

6. A method comprising the steps of:
a) defining a user profile based on characteristics of the user;
b) collecting electronic information corresponding to the user's customized profile for delivery to a client component of a computer from Internet sites;
c) storing the collected electronic information in an archive of a database;
d) sending data identifying the collected electronic information from the server to a client component;
e) receiving the data identifying the collected electronic information at the client component;
f) determining with the client component whether the electronic information was previously transmitted to the client component based on the data identifying the electronic information and electronic information previously stored by the client component;
g) generating and transmitting a message from the client component to the server indicating the electronic information previously sent to the client component;
h) receiving the message from the client component at the server;
i) deleting electronic information that has been previously sent to the client component from the archive, based on the received message;
j) compressing the electronic information remaining in the archive into a streaming format;
k) sending the electronic information to the client component;
l) decompressing the electronic information at the client component; and
m) providing the electronic information to the user via the computer.
